(19) United States
(12) Patent Application Publication
(10) Pub. No.: US 2012/0049634 A1
(43) Pub. Date: Mar. 1, 2012

(54) POWER CONVERSION USING DC AND AC CURRENT SHARING TO PRODUCE AN AC DISTRIBUTION OUTPUT

(76) Inventor: Samuel Martin BABB, Fort Collins, CO (US)

(21) Appl. No.: 12/862,543

(22) Filed: Aug. 24, 2010

(51) Int. Cl. H02M 7/02; H02J 1/00

(52) U.S. Cl. 307/82

(57) ABSTRACT

Examples provide DC current sharing at a first stage and AC current sharing at a second stage to provide an AC power distribution output.

### BACKGROUND

In the art of computing, power is supplied to a computer system. It is common for the power to undergo conversions in voltage, conversions between DC and AC, and conversions in AC frequency, before the power is delivered to the power consuming components in the computer system. It is also common to provide redundancy, so that a failure of a power converter or component does not interrupt operation of the computer system.

In one configuration known in the art, a computer rack is coupled to two or more power supply grids. The grids may supply AC power at the same voltage and frequency, or DC power at the same voltage. Alternatively, each grid may supply power having different characteristics.

In this configuration, each power supply grid is coupled to a rack power converter that converts the grid power supply to a common AC distribution, such as 380 Volts AC (VAC) at 150 kHz. The output of each rack power converter is provided to each server in the rack. Each server has a server power converter coupled the output of a rack power converter. Accordingly, there is one server power converter for each power supply grid. The server power converters convert the common AC distribution from the rack power converters to a DC distribution, such as 380 Volts DC (VDC). The output stages of the server power converters are joined into a current sharing configuration, with the resulting DC distribution being provided to blades in the server. Within the blades, DC-to-DC converters convert the DC distribution into the voltages required by the power consuming components within the blade.

The DC current sharing configuration provides redundancy. If one of the power grids fails, or if one of the rack power converters fails, or if one of the server power converters fails, the current sharing configuration ensures that power is provided via the other power path.

### BRIEF DESCRIPTION OF THE DRAWINGS

The Figures depict examples, implementations, and configurations.

FIG. 1 is a block diagram of a computing environment, in accordance with examples.

FIG. 2 is a block diagram showing server power converters and AC and DC current sharing of FIG. 1 in greater detail, in accordance with examples.

FIG. 3 is a block diagram showing server blades of FIG. 1 in greater detail, in accordance with examples.

FIG. 4 is a flowchart that illustrates a method, in accordance with examples.

### DETAILED DESCRIPTION

In the foregoing description, numerous details are set forth to provide an understanding of the examples. However, it will be understood by those skilled in the art that the examples may be practiced without these details. While a limited number of examples have been disclosed, those skilled in the art will appreciate numerous modifications and variations therefrom.

Examples relate to power distribution configurations in which power is delivered within a computing environment using high-frequency AC distribution. Compared to DC distribution configurations of the prior art, power distribution configurations in accordance with examples have lower loss, reduce the need for high voltage differential DC-to-DC conversions, and provide greater redundancy by providing current sharing at DC output stages and AC output stages, as will be discussed in greater detail below.

In the examples discussed below, typical power parameters are shown for a typical computer rack having typical servers that have typical blades. Those skilled in the art will recognize that other parameters may be used, as appropriate for the environment in which examples are deployed. In addition, in the Figures discussed below, conductors that join at a “T” intersection are electrically coupled, conductors that cross and have connection dots at the intersections are electrically coupled, and conductors that cross and do not have connection dots at the intersections are not electrically coupled. Also note that an implementation of an example would have additional signal ground connections and safety ground connections. To simplify the Figures and facilitate a better understanding of the examples, many ground connections have been omitted. However, those skilled in the art will recognize that such an implementation will be provided with additional ground connections. Finally, the terms “server” and “blade” are used herein to refer to a specific computing configuration known in the art, and examples are discussed with reference to this configuration. However, examples may be deployed in any type of computer system, or more generally, any type of electronic system.

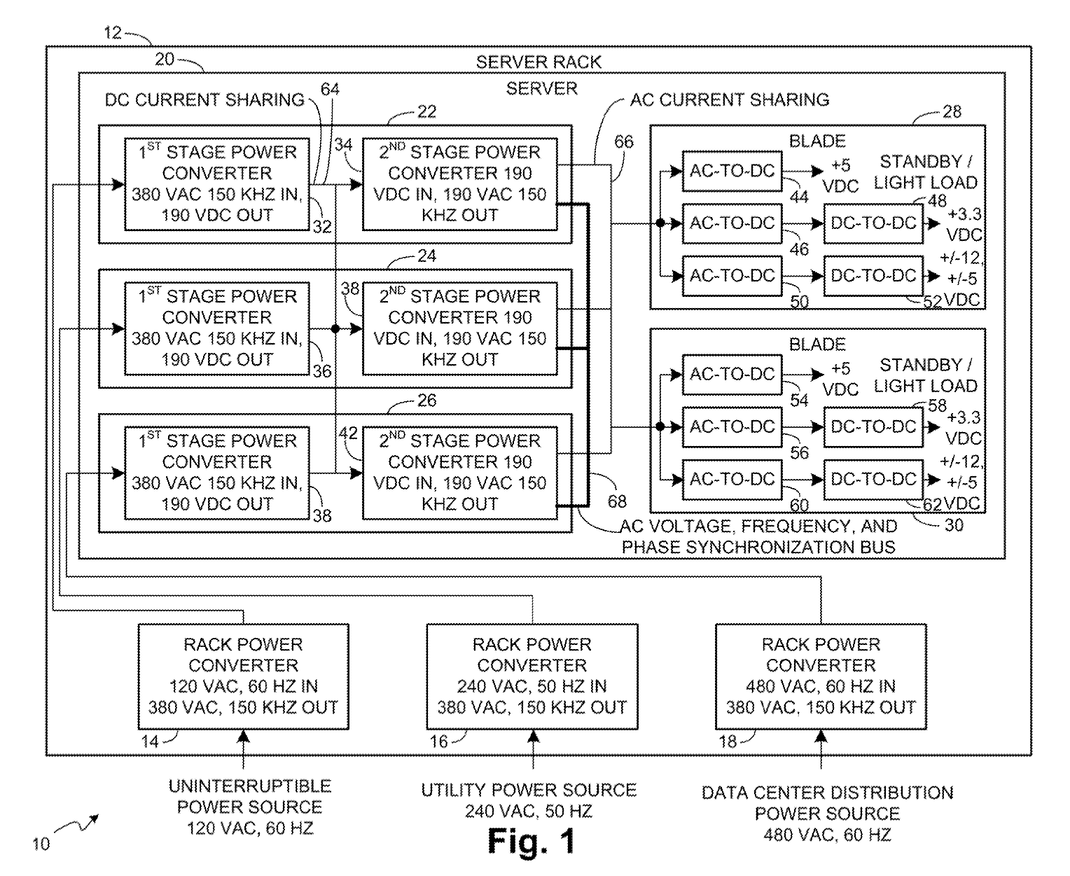

FIG. 1 is a block diagram of a computing environment 10 in accordance with examples. Computing environment 10 includes a server rack 12 that is coupled to several different power grids. The power grids are merely representative, and other power grids may be used. Typically, the power grids will be selected to provide redundancy, such that if one power grid fails, the other power grids are likely to remain operational.

Server rack 12 includes rack power converters 14, 16, and 18, with converter 14 coupled to an uninterruptible power source that supplies power at 120 VAC and 60 Hz, converter 16 coupled to a utility power source at 240 VAC and 50 Hz, and converter 18 coupled to a data center distribution power source at 480 VAC and 60 Hz. Each of the rack power converters provides an output at 380 VAC at 150 kHz.

Also within server rack 12 is server 20. Although only one server is shown in FIG. 1, it is common for a rack to hold multiple servers. Within server 20 are server power converters 22, 24, and 26. Each server power converter is coupled to one of the rack power converters. Also included in server 20 are blades 28 and 30. Although only two blades are shown in FIG. 1, it is common to provide additional blades in a server. Blades 28 and 30 receive power collectively from server power converters 22, 24, and 26.

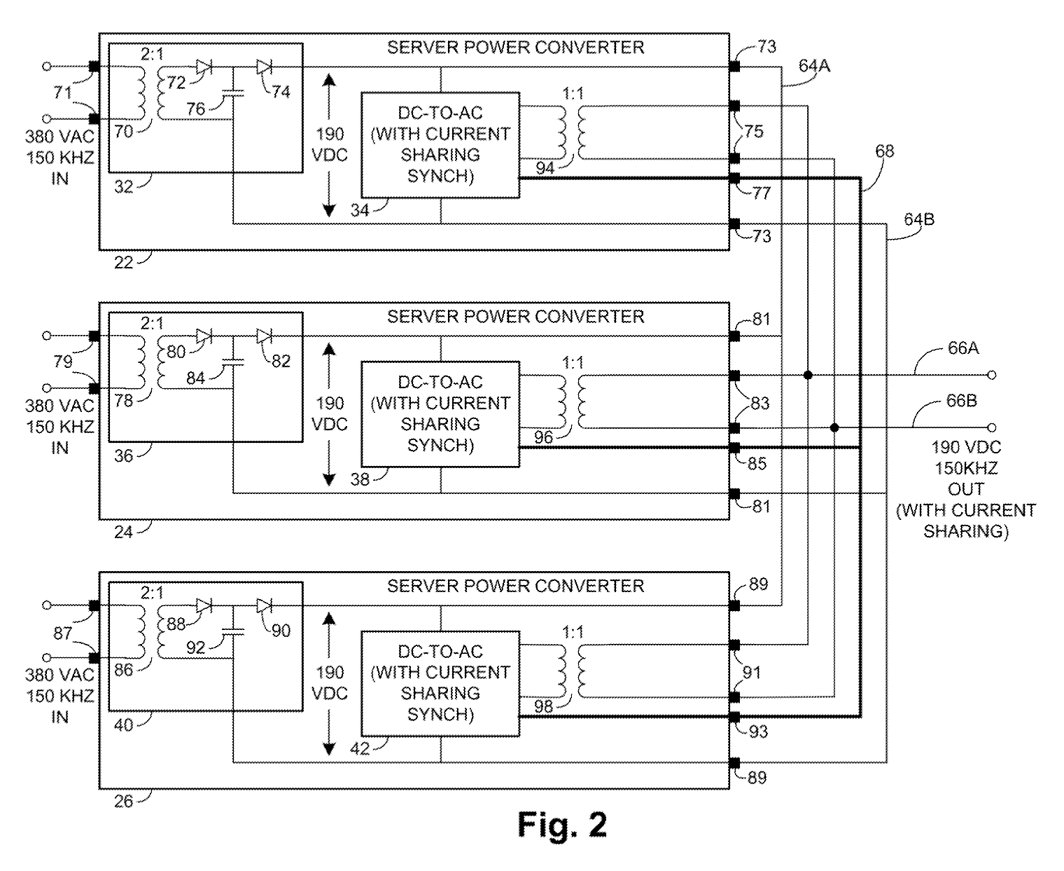

Each of the server power converters 22, 24, and 26 includes a first stage power converter 32, 36, and 38, respectively. The first stage power converters receive power from the rack power converters and provide isolation from the rack power converters, and convert the 380 VAC power supply at 150 kHz to 190 VDC. The outputs of the first stage power converters are intermediate DC power sources, and the intermediate DC power sources are configured in a DC current sharing configuration via conductors 64 joining current from the outputs. The DC current sharing configuration provides redundancy so that DC current is still available in the event of a failure of a power grid, a rack power converter, or a first stage power converter. The DC current sharing Configuration will be discussed below in greater detail below with reference to FIG. 2.

Each server power converter 22, 24, and 26 also includes a second stage power converter 34, 38, and 42, respectively. Each second stage power converter receives 190 VDC from conductor 64, which, as mentioned above, shares current from the first stage power converters. Each second stage power converter converts 190 VDC to 190 VAC at 150 kHz.

The outputs of the second stage power converters are arranged in an AC current sharing configuration via conductors 66 joining the outputs. The AC current sharing configuration provides a second level of redundancy, since operation of computing environment 10 will continue upon the failure of any of the second stage power converters.

Note that AC current sharing is more complex than DC current sharing because the frequency and phase of the AC outputs should be synchronized to facilitate current sharing. Accordingly, AC voltage, frequency and phase synchronization bus 68 is coupled to each of the second stage power converters 34, 38, and 42 to facilitate AC current sharing. The AC current sharing configuration will be discussed below in greater detail with reference to FIG. 2.

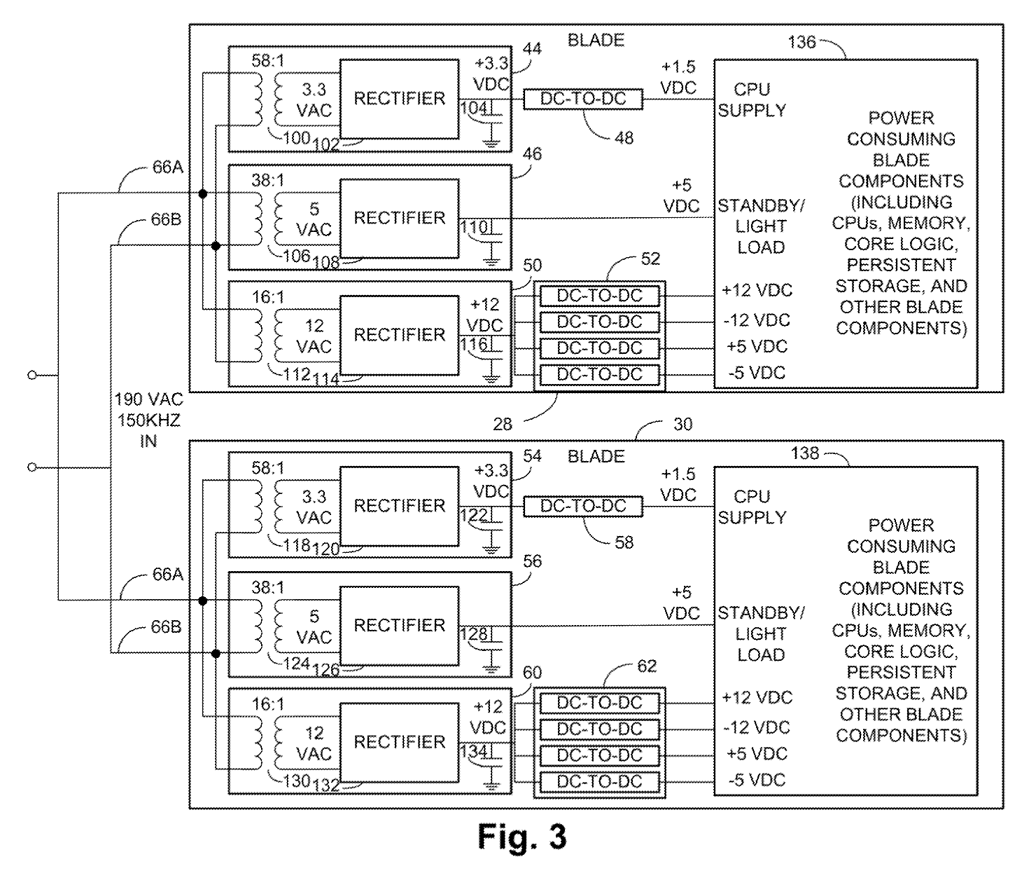

The high-frequency AC current-shared output of server power converters 22, 24, and 26 is provided to blades 28 and 30. Each blade has a variety of AC-to-DC and DC-to-DC converters to convert the 190 VAC at 150 kHz power supply into the DC voltages needed by the various components with the blades. Accordingly, blade 28 includes AC-to-DC power converters 44, 46, and 50, and DC-to-DC power converters 48 and 52. Similarly, blade 30 includes AC-to-DC converters 54, 56, and 60, and DC-to-DC power converters 58 and 62. The components within each blade 28 and 30 will be discussed in greater detail below with reference to FIG. 3.

As discussed above, the voltage and frequency parameters shown in FIG. 1 are typically, but in no way are examples limited to these parameters. For example, different voltages may be used. Furthermore, different AC frequencies and waveforms may be used. Selecting a frequency involves a tradeoff between loss and transformer size. In general, higher frequencies result is smaller and less expensive voltage conversion and isolation transformers. However, higher frequencies also result in higher power losses. Typically, the AC frequency will be in the range of one kilohertz to several megahertz, with 150 kHz as a representative suitable AC frequency for a rack-based server system. Also note that the shape of the AC waveform may vary. For example, the waveform may be a sinusoidal waveform or a quasi-square wave waveform. A quasi-square waveform may be rectified to a DC output with less filtering after rectification.

FIG. 2 is a block diagram showing server power converters 22, 24, and 26 and the AC and DC current sharing of FIG. 1 in greater detail. As discussed above, each server power converter 22, 24, and 26 includes a first stage power converter 32, 36, and 40, respectively, that converts 380 VAC at 150 kHz to 190 VDC. Each server power converter 22, 24, and 26 also includes a connector 71, 79, and 87, respectively, for receiving power from a rack power converter. First stage power converter 32 includes 2:1 transformer 70, diodes 72 and 74, and capacitor 76, first stage power converter 36 includes 2:1 transformer 78, diodes 80 and 82, and capacitor 84, and first stage power converter 40 includes 2:1 transfortner 86, diodes 88 and 90, and capacitor 92. The 2:1 transformers provide isolation and step down the 380 VAC power input to 190 VAC, and the diodes rectify the 190 VAC signal to 190 VDC, with the capacitors providing filtering.

The outputs of first stage power converters 32, 36, and 40 are arranged in a DC current sharing configuration via conductors 64A and 64B, which are coupled to DC current sharing connectors 73, 81, and 89 of server power converters 22, 24, and 26, respectively. In the DC current sharing configuration shown in FIG. 2, the output impedance of each first stage power convertor causes DC current sharing to reach a natural equilibrium. In other words, as the current draw of a first stage converter increases, the voltage provided by that first stage converter will drop slightly, causing other first stage converters to contribute more current, thereby causing all first stage power converters to reach equilibrium. As discussed above, DC current sharing provides redundancy, and the configuration can continue to provide DC current in the event of the failure of a supply grid, rack power converter, or first stage power converter.

The DC current shared outputs of the first stage power converters are provided to second stage power converters 34, 38, and 42, which are shown as DC-to-AC converters with current sharing synchronization. The second stage converters convert 190 VDC to 190 VAC at 150 kHz. AC current sharing is more complex than DC current sharing since the frequency and phase of the AC outputs should be aligned for optimal current sharing. AC voltage, frequency, and phase synchronization bus 68 facilitates this alignment. Bus 68 is coupled AC voltage, frequency, and phase synchronization connectors 77, 85, 93 of server power converters 22, 24, and 26, respectively.

Several methods are known in the art for aligning AC outputs to facilitate current sharing. For example, power convertors can negotiate to determine which converter will be a master and which will be slaves. The master provides an analog sync pulse, and the slaves use phase-locked loops (or circuits providing similar functionality) to lock unto the sync pulse. Alternatively, a digital link, such as an I²C bus, can be employed, with the convertors exchanging digital messages to align frequency and phase. In another example, an external global clock may be provided to each of the second stage power converters 34, 38, and 42. Within each of the second stage power converters, a phase-locked loop locks onto the global clock, with the output of the phase-locked loop in each second stage power converter driving the switching transistors that facilitate conversion of DC to AC.

Voltage regulation can be provided by the second stage converters reaching a natural equilibrium based on output impedance, as discussed above with reference to the first stage power converters. Alternatively, active monitoring of the voltage and current output of each second stage power converter can be used to regulate the output of each second stage power converter, thereby facilitating AC current sharing.

The output of each second stage power converter 34, 38, and 42 is coupled to a 1:1 transformer 94, 96, and 98, respectively. The 1:1 transformers provide isolation. Finally, AC current sharing is provided at the Outputs of the 1:1 transformers via conductors 66A and 66B, which are coupled to DC current sharing connectors 75, 83, and 91 of server power converters 22, 24, and 26, respectively. The AC current sharing provides a second level of redundancy, since operation may continue if any of the second stage power convertors 34, 38, or 42 fail. Furthermore, if a second stage power convertor fails, the first stage power converter in the server power converter containing the failed second stage power converter continues to contribute DC current to the remaining second stage power converters.

The 190 VAC current shared output at 150 kHz provided on conductors 66A and 66B is provided to blades 28 and 30, which are shown in greater detail in FIG. 3. Note that each server power converter has connectors for receiving power from a rack power converter, connectors for DC current sharing, connectors for AC current sharing and forming the 190 VAC current shared output, and connectors for coupling to AC voltage, frequency, and phase synchronization bus 68.

FIG. 3 is a block diagram showing blades 28 and 30 in greater detail. The 190 VAC power source at 150 kHz provided on conductors 66A and 66B in FIG. 2 is provided to blades 28 and 30. Within each blade, the AC-to-DC convertors have transformers that convert the 190 VAC power source to the desired output voltage. Accordingly, AC-to-DC convertors 44 and 54 have 58:1 transformers 100 and 118, respectively, to convert 190 VAC to 3.3 VAC, AC-to-DC convertors 46 and 56 have 38:1 transformers 106 and 124, respectively, to convert 190 VAC to 5 VAC, and converters 50 and 60 have 16:1 transformers 112 and 130, respectively, to convert 190 VAC to 12 VAC. The transformers can be relatively small and inexpensive due to the high frequency of the AC distribution power source. Also note that any suitable output voltage may be easily provided by selecting transformers having the proper turn ratio.

Each transformer is coupled to a rectifier, which in turn is coupled to a capacitor to produce a corresponding filtered DC power output. Accordingly, transformers 100, 106, 112, 118, 124, and 130 are coupled to rectifiers 102, 108, 114, 120, 126, and 132, respectively, which in turn are coupled to capacitors 104, 110, 116, 122, 128, and 134, respectively.

Block 136 of blade 28 and block 138 of blade 30 represent the power consuming components of a blade, including central processing units (CPUs), memory, core logic, persistent storage, and the like. As shown in FIG. 3, blocks 136 and 138 receive a +1.5 VDC power source for CPUs. This power source may also be used for other integrated circuits (ICs) and components that require a voltage in this range. The 1.5 VDC power source for blade 28 is provided by AC-to-DC converter 44 and DC-to-DC converter 48, and the 1.5 VDC power source for blade 30 is provided by AC-to-DC converter 54 and DC-to-DC converter 58.

Each block 136 and 138 is provided with a +5 VDC power source for standby power and light loads. Since the current draw required by standby power and light loads is relatively low, the inductance of transformers 106 and 124, along with the capacitance of capacitors 110 and 128 provide sufficient energy storage to provide a suitable power output for this purpose without the need of an additional DC-to-DC converter. Accordingly, the output of AC-to-DC converter 46 is provided directly to block 136, and the output of AC-to-DC converter 56 is provided directly to block 138.

Finally, +5, −5, +12, and −12 VDC are common voltages for many components in computer systems. In blade 28, these voltages are provided by coupling the output of AC-to-DC converter 50 to DC-to-DC convertors 52, which generate these voltages and supply the voltages to block 136. Similarly, in blade 30, these voltages are provided by coupling the output of AC-to-DC converter 60 to DC-to-DC convertors 62, which generate these voltages and supply the voltages to block 138.

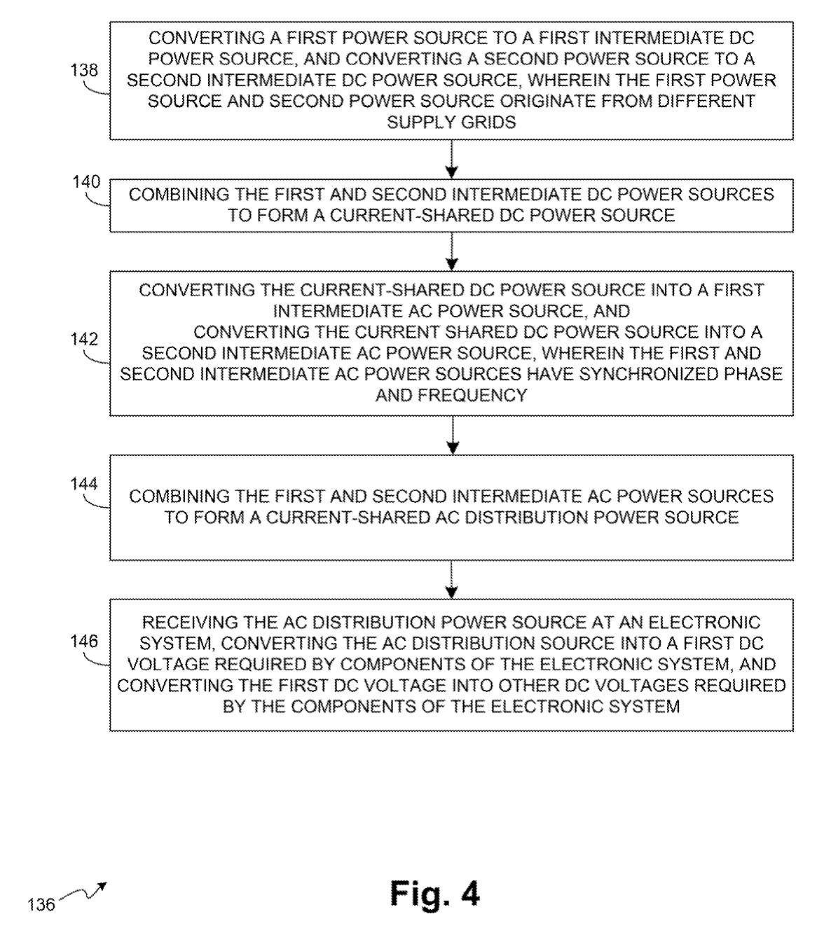

FIG. 4 shows a flowchart 136 that illustrates a method for practicing examples. At block 138, a first power source is converted into a first intermediate DC power source, and a second power source is converted into a second intermediate power source, wherein the first power source and the second power source originate from difference supply grids. For example, in FIG. 1, the first power source may be the uninterruptable power source coupled to rack power converter 14, which in turn is coupled to server power supply 22, and the second power source may be the utility power source coupled to rack power converter 16, which in turn is coupled to server power converter 24. The first intermediate DC power source may be the output of first stage power converter 32, and the second intermediate DC power source may be the output of first stage power converter 36. Control passes to block 140.

At block 140, the first and second intermediate DC power sources are combined to form a current-shared DC power source. For example, in FIG. 2, the first and second intermediate DC power sources may be combined by conductors 64A and 64B. Control passes to block 142.

At block 142, the current shared DC power source is converted into a first intermediate AC power source and a second intermediate AC power source, with the first and second intermediate AC power sources having synchronized phase and frequency. For example, in FIG. 1, second stage power converter 34 produces the first intermediate AC power source, and second stage power converter 38 produces the second intermediate AC power source, with AC voltage, frequency, and phase synchronization bus 68 facilitating cooperation between second stage power converters 34 and 38 to synchronize phase and frequency. Control passes to block 144.

At block 144, the first and second intermediate AC power sources are combined to form a current-shared AC distribution power source. For example, in FIG. 2 the outputs of second stage power converters 34 and 38 are combined by conductors 66A and 66B. Control passes to block 146.

Finally, at block 146 the AC distribution power source is received by an electronic system, with the electronic system converting the AC distribution source into a first DC voltage required by components of the electronic system, and additional DC voltages being required by the electronic system being provided by converting the first DC voltage into the other DC voltages. For example, in FIG. 3, voltages required by block 136 of blade 28 are supplied by AC-to-DC converter 46, and are also supplied by AC-to-DC converter 50 in cooperation with DC-to-DC converters 52.

Examples provide a high frequency AC power distribution system that provides additional redundancy by providing both AC and DC current sharing. By providing high frequency AC power to an electronic system, such as a server blade, any DC voltage can be generated by small inexpensive transformers in combination with rectification and filtering, and additional DC voltages can be provided by DC-to-DC converters.

In the foregoing description, numerous details are set forth to provide an understanding of the examples. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the true spirit and scope of the examples.

What is claimed is:

1. A method of distributing power comprising:
converting a first power source to a first intermediate DC power source;
converting a second power source to a second intermediate DC power source;
combining the first and second intermediate DC power sources to form a current-shared DC power source;
converting the current-shared DC power source into a first intermediate AC power source;
converting the current shared DC power source into a second intermediate AC power source; and
combining the first and second intermediate AC power sources to form a current-shared AC distribution power source.

2. The method of claim 1 wherein the first power source and the second power source originate from different power supply grids.

3. The method of claim 1 and further comprising:
synchronizing phase and frequency of the first and second intermediate AC power sources.

4. The method of claim 1 and further comprising:
receiving the AC distribution power source at an electronic system; and
converting the AC distribution source into a first DC voltage required by components of the electronic system.

5. The method of claim 4 and further comprising:
converting the first DC voltage into other DC voltages required by the components of the electronic system.

6. A computing environment comprising:
computing components that require a variety of DC voltages;
a plurality of first stage power converters, with each first stage power converter coupled to a power source and producing an intermediate DC power output;
a DC current joiner for combining the intermediate DC power outputs of all first stage power converters to form a current-shared DC power output,
a plurality of second stage power converters, with each second stage power converter coupled to the current-shared DC power output and providing an intermediate AC power output;
an AC current joiner for combining the intermediate AC power outputs of all second stage power converters to form a current-shared AC distribution power output;
AC-to-DC convertors coupled to the current-shared AC distribution power output, for providing the variety of DC voltages.

7. The computing environment of claim 6 and further comprising:
a rack; and
a plurality of rack power converters, with each rack power converter coupled to a power grid and producing a power source that is coupled to a first stage power converter.

8. The computing environment of claim 7 wherein the power grids that are coupled to the plurality of rack power converters are independent and are derived from different sources and provide redundancy.

9. The computing environment of claim 6 wherein each member of the plurality of first stage power converters is paired with a member of the plurality of second stage power converters to form a server power converter.

10. The computing environment of claim 6 wherein the computing components that require a variety of DC voltages reside on a plurality of server blades.

11. The computing environment of claim 6 and further comprising:
a frequency and phase synchronization bus coupled to each of the second stage power convertors for facilitating communication between the second stage power convertors to align frequency and phase of the intermediate AC power outputs.

12. The computing environment of claim 6 wherein the AC distribution power output has a frequency of at least one kilohertz.

13. The computing environment of claim 6 and further comprising;
DC-to-DC converters coupled to at least some of the AC-to-DC converters, for providing at least some of the variety of DC voltages.

14. The computing environment of claim 6 and further comprising;
a rack;
a plurality of rack power converters, with each rack power converter coupled to a power grid and producing a power source that is coupled to a first stage power converter, wherein the power grids that are coupled to the plurality of rack power converters are independent and are derived from different sources and provide redundancy, and wherein each member of the plurality of first stage power converters is paired with a member of the plurality of second stage power converters to form a server power converter;
DC-to-DC converters coupled to at least some of the AC-to-DC converters, for providing at least some of the variety of DC voltages, wherein the computing components that require a variety of DC voltages reside on a plurality of server blades; and
a frequency, phase, and voltage synchronization bus coupled to each of the second stage power convertors for facilitating communication between the second stage power convertors to align frequency, phase, and voltage of the intermediate AC power outputs, wherein the AC distribution power output has a frequency of at least one kilohertz.

15. A power converter comprising:
a first stage power converter having a connector for receiving a power source derived from a power grid and forming an intermediate DC output;
a DC current sharing connector coupled to the intermediate DC output, for participating in DC current sharing with other power converters to form a current-shared DC output;
a second stage power converter coupled to the current-shared DC output and forming an intermediate AC output; and
an AC current sharing connector coupled to the intermediate AC output, for participating in AC current sharing with other power converters to form an AC power distribution output.

16. The power converter of claim 15 and further comprising:
a phase and frequency synchronization bus connector for carrying signals that facilitate communication between power converters to align phase and frequency of the intermediate AC outputs in support of AC current sharing.

17. The power converter of claim 16 wherein the phase and frequency synchronization bus is a phase, frequency, and voltage synchronization bus that also facilitates communication between power converters to align voltages of the intermediate AC outputs in support of AC current sharing.

18. The power converter of claim 15 wherein the first stage power converter includes a transformer to isolate the power source derived from the power grid from the intermediate DC output.

19. The power converter of claim 15 wherein the second stage power converter includes a transformer to isolate the intermediate AC output from the AC power distribution output.

20. The power converter of claim 15 and further comprising:
a phase, frequency, and voltage synchronization bus connector for facilitating communication between power converters to align phase, frequency, and voltage of the intermediate AC outputs in support of AC current sharing, wherein the first stage power converter includes a transformer to isolate the power source derived from the power grid from the intermediate DC output, and wherein the second stage power converter includes a transformer to isolate the intermediate AC output from the AC power distribution output.
